(19) United States
(12) Patent Application Publication
(10) Pub. No.: US 2017/0036146 A1
(43) Pub. Date: Feb. 9, 2017

(54) NONWOVEN FIBROUS STRUCTURES INCLUDING PHENOLIC RESIN AND IONIC REINFORCEMENT MATERIAL, AND METHODS

(71) Applicant: 3M INNOVATIVE PROPERTIES COMPANY, St. Paul, MN (US)

(72) Inventors: Saibh Morrissey, Dublin (IE); Jean-Marie Coant, Saint-Denis (FR); Jean Le Normand, Versailles (FR)

(21) Appl. No.: 15/303,598

(22) PCT Filed: Apr. 21, 2015
(86) PCT No.: PCT/US2015/026786

§ 371 Date: Oct. 12, 2016

Related U.S. Application Data
(60) Provisional application No. 61/985,118, filed on Apr. 28, 2014.

(51) Int. Cl. B01D 39/16; D04H 1/4291; D04H 1/64; D04H 1/02

(52) U.S. Cl. CPC B01D 39/163; D04H 1/02; D04H 1/4291; D04H 1/64; B01D 2239/0442; B01D 2239/0407; B01D 2239/086; B01D 2239/10

(57) ABSTRACT

Nonwoven fibrous structures and related media with ionic reinforcement material and methods of forming the same includes bonding at least a portion of the population of fibers together with an ionic reinforcement material. Nonwoven fibrous structures can be utilized as a mat, a web, a sheet, a scrim, or a combination thereof. Methods of making nonwoven fibrous structures and related media with ionic reinforcement material made according to the methods, are also disclosed.

### TECHNICAL FIELD

The present disclosure relates to nonwoven fibrous structures and related media with ionic reinforcement material and methods of forming the same.

### BACKGROUND

Nonwoven fibrous webs have been used to produce a variety of absorbent articles that are useful, for example, as absorbent wipes for surface cleaning, as wound dressings, as gas and liquid absorbent or filtration media, and as barrier materials for sound absorption.

### SUMMARY

Although some methods of forming nonwoven fibrous webs are known, the art continually seeks new methods of forming and/or bonding nonwoven webs, particularly air-laid nonwoven fibrous webs having particular characteristics with a relatively high cross direction (CD) tensile strength and a relatively high machine direction (MD) tensile strength.

The present disclosure relates to a method of making a nonwoven fibrous structure (e.g., a nonwoven fibrous web), including: introducing a plurality of fibers into a forming chamber, dispersing the fibers within the forming chamber to form a population of individual fibers suspended in a gas, collecting the population of fibers as a nonwoven fibrous structure on a collector, applying a phenolic resin material to the population of fibers, applying an ionic liquid material to the population of fibers, and bonding at least a portion of the population of fibers together by curing the applied binder, the applied ionic liquid material, or both the applied binder and the applied ionic liquid material. In some exemplary embodiments, the method includes where the phenolic resin material comprises a phenolic resin and water. In certain exemplary embodiments, the method includes where the phenolic resin undergoes phase separation from the phenolic resin material.

In some exemplary embodiments, the phase separation of the phenolic resin from the phenolic resin material comprises precipitating the phenolic resin by removing at least some of the water from the phenolic resin material. In certain exemplary embodiments, the ionic liquid material comprises water. In some exemplary embodiments, bonding at least the portion of the population of fibers together by curing includes removing water from at least one of the phenolic resin material or the ionic liquid material to cause bonding of the portion of the population of fibers together. In certain exemplary embodiments, the method includes applying the phenolic resin material takes place before applying the ionic liquid material.

In some exemplary embodiments, the method includes applying the phenolic resin material takes place after applying the ionic liquid material. In certain exemplary embodiments, the method includes applying the phenolic resin material and applying the ionic liquid material take place substantially simultaneously. In some exemplary embodiments, the phenolic resin material and the ionic liquid material are combined to form a combined mixture before application to the population fibers.

In some exemplary embodiments, the method includes bonding at least the portion of the population of fibers together by curing includes heating the portion of the population of fibers. In certain exemplary embodiments, bonding at least the portion of the population of fibers together by curing provides a nonwoven fibrous structure with a tensile strength that is greater than a nonwoven fibrous structure formed by bonding at least the portion of the population of fibers together in the absence of the ionic liquid material. In some exemplary embodiments, the ionic liquid material is an ionic liquid solution in a solvent, optionally wherein the ionic liquid solution is an aqueous solution. In certain exemplary embodiments, the ionic liquid material comprises at least one cation and at least one anion. In certain exemplary embodiments, the at least one cation is selected from the group consisting of nitrogen containing heterocyclic cations, ammonium, phosphonium, or sulfonium; and further wherein the at least one anion is selected from the group consisting of halogen anions, fluorine containing anions, alkyl sulfate anions, alkyl phosphate anions, acetate, dicyanamide (N(CN)₂), or thiocyanate (SCN). In some exemplary embodiments, the method includes applying the ionic liquid material comprises spraying the ionic liquid material, roll coating the ionic liquid material, dip coating the ionic liquid material, or a combination thereof.

In some exemplary embodiments, the method includes applying a thermosetting binder to the population fibers. In certain exemplary embodiments, the thermosetting binder is applied from the phenolic resin material, the ionic liquid material, a mixture separate from the phenolic resin material and the ionic liquid material, or a combination thereof. In some exemplary embodiments, the phenolic resin material is a phenolic resin liquid mixture. In certain exemplary embodiments, the method includes removing a portion of the applied phenolic resin liquid mixture, the ionic liquid material, or both the liquid mixtures, from the population of fibers. In some exemplary embodiments, the ionic reinforcement material provides at least one distinguishing characteristic to the nonwoven fibrous structure selected from the group consisting of a fire retardant characteristic, an antistatic characteristic, an antibacterial characteristic, an antimicrobial characteristic, an antifungal characteristic, or a combination thereof. In certain exemplary embodiments, the population of fibers includes fibers selected from the group consisting of mono-component fibers, multi-component fibers, crimped fibers, or a combination thereof.

In some exemplary embodiments, the population of fibers includes fibers selected from the group consisting of staple fibers, melt blown fibers, natural fibers, or a combination thereof. In certain exemplary embodiments, the nonwoven fibrous structure includes a population of particulates bonded to the nonwoven fibrous structure, further wherein the particulates are selected from the group consisting of abrasive particulates, detergent particulates, anti-bacterial particulates, adsorbent particulates, absorbent particulates, or a combination thereof. In some exemplary embodiments, the nonwoven fibrous structure is a structure selected from the group consisting of a mat, a web, a sheet, a scrim, or a combination thereof.

The disclosure also relates to a nonwoven fibrous structure prepared according to the method described herein. In addition, the disclosure relates to a nonwoven fibrous structure comprising a population of randomly oriented fibers bonded together using a phenolic binder and an ionic reinforcement material. In some exemplary embodiments, the population of randomly oriented fibers is bonded together with a reaction product of the phenolic binder and the ionic reinforcement material. In certain exemplary embodiments, the ionic reinforcement material is a residual material from an application of an ionic liquid and the phenolic binder to the fibers. In some exemplary embodiments, the ionic liquid comprises water, one or more cations, and one or more anions. In further embodiments, the ionic liquid comprises an imidazolium cation with a corresponding anion.

In some exemplary embodiments, the nonwoven fibrous structure exhibits at least one distinguishing characteristic selected from the group consisting of a fire retardant characteristic, an antistatic characteristic, an antibacterial characteristic, an antimicrobial characteristic, or an antifungal characteristic. In certain exemplary embodiments, the ionic reinforcement material provides the at least one distinguishing characteristic. In some exemplary embodiments, the ionic reinforcement material provides at least two of the distinguishing characteristics. In certain exemplary embodiments, the population of fibers includes fibers selected from the group consisting of mono-component fibers, multi-component fibers, crimped fibers, or a combination thereof.

In some exemplary embodiments, the population of fibers includes fibers selected from the group consisting of staple fibers, melt blown fibers, natural fibers, or a combination thereof. In certain exemplary embodiments, the population of fibers includes thermoplastic (co)polymer fibers further comprising a (co)polymer selected from poly(propylene), poly(ethylene), poly(butane), poly(ethylene) terephthalate, poly(butylene) terephthalate, poly(ethylene) napthalate, poly(amide), poly(urethane), poly(lactic acid), poly(vinyl)alcohol, poly(phenylene) sulfide, poly(sulfone), liquid crystalline polymer, poly(ethylene)-co-poly(vinyl)acetate, poly(acrylonitrile), cyclic poly(olefin), poly(oxymethylene), poly(olefinic) thermoplastic elastomers, recycled fibers containing any of the preceding thermoplastic (co)polymers, or a combination thereof. In some exemplary embodiments, the population of fibers includes natural fibers selected from cotton, wool, jute, agave, sisal, coconut, soybean, hemp, viscose, bamboo, or a combination thereof. In certain exemplary embodiments, the nonwoven fibrous structure includes a population of particulates bonded to the nonwoven fibrous structure, further wherein the particulates are selected from the group consisting of abrasive particulates, detergent particulates, anti-bacterial particulates, adsorbent particulates, absorbent particulates; or a combination thereof.

In some exemplary embodiments, the population of particulates exhibits a median particle diameter of from 0.1 micrometer to 1,000 micrometers. In certain exemplary embodiments, the population of fibers exhibits a median fiber diameter of from 1 micrometer to 50 micrometers. In some exemplary embodiments, the nonwoven fibrous structure is a structure selected from the group consisting of a mat, a web, a sheet, a scrim, or a combination thereof.

Various exemplary embodiments of the present disclosure are further illustrated by the following listing of exemplary embodiments, which should not be construed to unduly limit the present disclosure:

### LISTING OF EXEMPLARY EMBODIMENTS

A. A method of making a nonwoven structure, comprising:
   a. introducing a plurality of fibers into a forming chamber;
   b. dispersing the fibers within the forming chamber to form a population of individual fibers suspended in a gas;
   c. collecting the population of fibers as a nonwoven fibrous web on a collector;
   d. applying a phenolic resin material to the population of fibers; applying an ionic liquid material to the population of fibers; and
   e. bonding at least a portion of the population of fibers together by curing the applied phenolic resin material, the applied ionic liquid material, or both the applied phenolic resin material and the applied ionic liquid material.
B. The method of embodiment A, wherein the phenolic resin material comprises a phenolic resin and water.
C. The method of embodiment B, wherein the phenolic resin undergoes phase separation from the phenolic resin material.
D. The method of embodiment C, wherein the phase separation of the phenolic resin from the phenolic resin material comprises precipitating the phenolic resin by removing at least some of the water from the phenolic resin material.
E. The method of any one of embodiments B-D, wherein the ionic liquid material comprises water.
F. The method of embodiment E, wherein bonding at least the portion of the population of fibers together by curing includes removing water from at least one of the phenolic resin material or the ionic liquid material to cause bonding of the portion of the population of fibers together.
G. The method of any one of embodiments A-F, wherein applying the phenolic resin material takes place before applying the ionic liquid material.
H. The method of any one of embodiments A-F, wherein applying the phenolic resin material takes place after applying the ionic liquid material.
I. The method of any one of embodiments A-F, wherein applying the phenolic resin material and applying the ionic liquid material take place substantially simultaneously.
J. The method of embodiment I, wherein the phenolic resin material and the ionic liquid material are combined to form a combined mixture before application to the population fibers.
K. The method of any one of embodiments A-J, wherein bonding at least the portion of the population of fibers together by curing includes heating the portion of the population of fibers.
L. The method of any one of embodiments A-K, wherein bonding at least the portion of the population of fibers together by curing provides a nonwoven fibrous structure with a tensile strength that is greater than a nonwoven fibrous structure formed by bonding at least the portion of the population of fibers together in the absence of the ionic liquid material.
M. The method of any one of embodiments A-L, wherein the ionic liquid material is an ionic liquid solution in a solvent, optionally wherein the ionic liquid solution is an aqueous solution.
N. The method of any one of embodiments A-M, wherein the ionic liquid material comprises at least one cation and at least one anion.
O. The method of any one of embodiments A-N, wherein the at least one cation is selected from the group consisting of nitrogen containing heterocyclic cations, ammonium, phosphonium, or sulfonium; and further wherein the at least one anion is selected from the group consisting of halogen anions, fluorine containing anions, alkyl sulfate anions, alkyl phosphate anions, acetate, dicyanamide (N(CN)₂), or thiocyanate (SCN).
P. The method of any one of embodiments A-O, wherein applying the ionic liquid material comprises spraying the ionic liquid material, roll coating the ionic liquid material, dip coating the ionic liquid material, or a combination thereof
Q. The method of any one of embodiments A-P, further comprising applying a thermosetting binder to the population fibers.
R. The method of embodiment Q, wherein the thermosetting binder is applied from the phenolic resin material, the ionic liquid material, a mixture separate from the phenolic resin material and the ionic liquid material, or a combination thereof.
S. The method of any one of embodiments A-R, wherein the phenolic resin material is a phenolic resin liquid mixture.
T. The method of embodiment S, further comprising removing a portion of the applied phenolic resin liquid mixture, the ionic liquid material, or both the liquid mixtures, from the population of fibers.
U. The method of any one of embodiments A-T, wherein the ionic reinforcement material provides at least one distinguishing characteristic to the nonwoven fibrous structure selected from the group consisting of a fire retardant characteristic, an antistatic characteristic, an antibacterial characteristic, an antimicrobial characteristic, an antifungal characteristic, or a combination thereof.
V. The method of any one of embodiments A-U, wherein the population of fibers includes fibers selected from the group consisting of mono-component fibers, multi-component fibers, crimped fibers, or a combination thereof.
W. The method of any one of embodiments A-V, wherein the population of fibers includes fibers selected from the group consisting of staple fibers, melt blown fibers, natural fibers, or a combination thereof
X. The method of any one of embodiments A-W, wherein the nonwoven fibrous structure includes a population of particulates bonded to the nonwoven fibrous structure, further wherein the particulates are selected from the group consisting of abrasive particulates, detergent particulates, anti-bacterial particulates, adsorbent particulates, absorbent particulates, or a combination thereof
Y. The method of any one of embodiments A-X, wherein the nonwoven fibrous structure is a structure selected from the group consisting of a mat, a web, a sheet, a scrim, or a combination thereof
Z. A nonwoven fibrous structure prepared according to the method of any one of embodiments A-Y.
AA. A nonwoven structure comprising:
   a. a population of randomly oriented fibers bonded together using a phenolic binder and an ionic reinforcement material.
BB. The nonwoven fibrous structure of embodiment AA, wherein the population of randomly oriented fibers is bonded together with a reaction product of the phenolic binder and the ionic reinforcement material.
CC. The nonwoven structure of embodiment AA or BB, wherein the ionic reinforcement material is a residual material from an application of an ionic liquid and the phenolic binder to the fibers.
DD. The nonwoven fibrous structure of embodiment CC, wherein the ionic liquid comprises water, one or more cations, and one or more anions.
EE. The nonwoven structure of embodiment DD, wherein the ionic liquid comprises an imidazolium cation with a corresponding anion.
FF. The nonwoven structure of any one of embodiments AA-EE, exhibiting at least one distinguishing characteristic selected from the group consisting of a fire retardant characteristic, an antistatic characteristic, an antibacterial characteristic, an antimicrobial characteristic, or an antifungal characteristic.
GG. The nonwoven fibrous structure of embodiment FF, wherein the ionic reinforcement material provides the at least one distinguishing characteristic.
HH. The nonwoven fibrous structure of embodiment GG, wherein the ionic reinforcement material provides at least two of the distinguishing characteristics.
II. The nonwoven fibrous structure of any one of embodiments AA-HH, wherein the population of fibers includes fibers selected from the group consisting of mono-component fibers, multi-component fibers, crimped fibers, or a combination thereof.
JJ. The nonwoven fibrous structure of any one of embodiments AA-II, wherein the population of fibers includes fibers selected from the group consisting of staple fibers, melt blown fibers, natural fibers, bio-based fibers, or a combination thereof
KK. The nonwoven fibrous structure of any one of embodiments AA-JJ, wherein the population of fibers includes thermoplastic (co)polymer fibers further comprising a (co)polymer selected from poly(propylene), poly(ethylene), poly(butane), poly(ethylene) terephthalate, poly(butylene) terephthalate, poly(ethylene) napthalate, poly(amide), poly(urethane), poly(lactic acid), poly(vinyl)alcohol, poly(phenylene) sulfide, poly(sulfone), liquid crystalline polymer, poly(ethylene)-co-poly(vinyl)acetate, poly(acrylonitrile), cyclic poly(olefin), poly(oxymethylene), poly(olefinic) thermoplastic elastomers, recycled fibers containing any of the preceding thermoplastic (co)polymers, or a combination thereof
LL. The nonwoven fibrous structure of any one of embodiments AA-KK, wherein the population of fibers includes natural fibers selected from cotton, wool, jute, agave, sisal, coconut, soybean, hemp, viscose, bamboo, or a combination thereof
MM. The nonwoven fibrous structure of any one of embodiments AA-LL, wherein the nonwoven fibrous structure includes a population of particulates bonded to the nonwoven fibrous structure, further wherein the particulates are selected from the group consisting of abrasive particulates, detergent particulates, anti-bacterial particulates, adsorbent particulates, absorbent particulates; or a combination thereof
NN. The nonwoven fibrous structure of any one of embodiments AA-MM, wherein the population of particulates exhibits a median particle diameter of from 0.1 micrometer to 1,000 micrometers.
OO. The nonwoven fibrous structure of any one of embodiments AA-NN, wherein the population of fibers exhibits a median fiber diameter of from 1 micrometer to 50 micrometers.
PP. The nonwoven fibrous structure of any one of embodiments AA-OO, wherein the nonwoven fibrous structure is a structure selected from the group consisting of a mat, a web, a sheet, a scrim, or a combination thereof.

Various aspects and advantages of embodiments of the presently disclosed invention have been summarized. The above Summary is not intended to describe each illustrated embodiment or every implementation of the presently disclosed invention. The Drawings and the Detailed Description that follow more particularly exemplify certain preferred embodiments using the principles disclosed herein.

### BRIEF DESCRIPTION OF THE DRAWINGS

Exemplary embodiments of the present disclosure are further described with reference to the appended figures, wherein:

FIG. 1 is a perspective view of an exemplary nonwoven fibrous structure of the present disclosure.

FIG. 2 is an exploded view of a portion of the exemplary nonwoven fibrous structure of FIG. 1, illustrating one exemplary embodiment of the present disclosure.

### DETAILED DESCRIPTION

As used in this specification and the appended embodiments, the singular forms “a”, “an”, and “the” include plural referents unless the content clearly dictates otherwise. Thus, for example, reference to fine fibers containing “a compound” includes a mixture of two or more compounds. As used in this specification and the appended embodiments, the term “or” is generally employed in its sense including “and/or” unless the content clearly dictates otherwise.

As used in this specification, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

For the following Glossary of defined terms, these definitions shall be applied for the entire application, unless a different definition is provided in the claims or elsewhere in the specification.

### GLOSSARY

“Nonwoven fibrous web” or “nonwoven fibrous structure” means an article or sheet having a structure of individual fibers or fibers, which are interlaid, but not in an identifiable manner as in a knitted fabric. Nonwoven fabrics or webs have been formed from many processes such as for example, meltblowing processes, air-laying processes, and bonded carded web processes.

“Die” means a processing assembly for use in polymer melt processing and fiber extrusion processes, including but not limited to meltblowing and spun-bonding.

“Meltblowing” and “meltblown process” means a method for forming a nonwoven fibrous web by extruding a molten fiber-forming material through a plurality of orifices in a die to form fibers while contacting the fibers with air or other attenuating fluid to attenuate the fibers into fibers, and thereafter collecting the attenuated fibers. An exemplary meltblowing process is taught in, for example, U.S. Pat. No. 6,607,624 (Berrigan et al.).

“Meltblown fibers” means fibers prepared by a meltblowing or meltblown process.

“Spun-bonding” and “spun bond process” mean a method for forming a nonwoven fibrous structure by extruding molten fiber-forming material as continuous or semi-continuous fibers from a plurality of fine capillaries of a spinneret, and thereafter collecting the attenuated fibers. An exemplary spun-bonding process is disclosed in, for example, U.S. Pat. No. 3,802,817 to Matsuki et al.

“Spun bond fibers” and “spun-bonded fibers” mean fibers made using spun-bonding or a spun bond process. Such fibers are generally continuous fibers and are entangled or point bonded sufficiently to form a cohesive nonwoven fibrous web such that it is usually not possible to remove one complete spun bond fiber from a mass of such fibers. The fibers may also have shapes such as those described, for example, in U.S. Pat. No. 5,277,976 to Hogle et al., which describes fibers with unconventional shapes.

“Carding” and “carding process” mean a method of forming a nonwoven fibrous web webs by processing staple fibers through a combing or carding unit, which separates or breaks apart and aligns the staple fibers in the machine direction to form a generally machine direction oriented fibrous nonwoven web. An exemplary carding process is taught in, for example, U.S. Pat. No. 5,114,787 to Chaplin et al.

“Bonded carded web” refers to nonwoven fibrous web formed by a carding process wherein at least a portion of the fibers are bonded together by methods that include for example, thermal point bonding, autogenous bonding, hot air bonding, ultrasonic bonding, needle punching, calendering, application of a spray adhesive, and the like.

“Calendering” means a process of passing a nonwoven fibrous web through rollers with application of pressure to obtain a compressed and bonded fibrous nonwoven web. The rollers may optionally be heated.

“Densification” means a process whereby fibers which have been deposited either directly or indirectly onto a filter winding arbor or mandrel are compressed, either before or after the deposition, and made to form an area, generally or locally, of lower porosity, whether by design or as an artifact of some process of handling the forming or formed filter. Densification also includes the process of calendering webs.

“Non-hollow” with particular reference to projections extending from a major surface of a nonwoven fibrous structure means that the projections do not contain an internal cavity or void region other than the microscopic voids (i.e. void volume) between randomly oriented discrete fibers.

“Randomly oriented” with particular reference to a population of fibers means that the fiber bodies are not substantially aligned in a single direction.

“Air-laying” is a process by which a nonwoven fibrous web layer can be formed. In the air-laying process, bundles of small fibers having typical lengths ranging from about 3 to about 52 millimeters (mm) are separated and entrained in an air supply and then deposited onto a forming screen, usually with the assistance of a vacuum supply. The randomly oriented fibers may then be bonded to one another using, for example, thermal point bonding, autogenous bonding, hot air bonding, needle punching, calendering, a spray adhesive, and the like. An exemplary air-laying process is taught in, for example, U.S. Pat. No. 4,640,810 to Laursen et al.

“Particulate loading” or a “particle loading process” means a process in which particulates are added to a fiber stream or web while it is forming. Exemplary particulate loading processes are taught in, for example, U.S. Pat. No. 4,818,464 to Lau and U.S. Pat. No. 4,100,324 to Anderson et al.

“Particulate” and “particle” are used substantially interchangeably. Generally, a particulate or particle means a small distinct piece or individual part of a material in finely divided form. However, a particulate may also include a collection of individual particles associated or clustered together in finely divided form. Thus, individual particulates used in certain exemplary embodiments of the present disclosure may clump, physically intermesh, electro-statically associate, or otherwise associate to form particulates. In certain instances, particulates in the form of agglomerates of individual particulates may be intentionally formed such as those described in U.S. Pat. No. 5,332,426 (Tang et al.).

“Layer” means a single stratum formed between two major surfaces. A layer may exist internally within a single web, e.g., a single stratum formed with multiple strata in a single web having first and second major surfaces defining the thickness of the web. A layer may also exist in a composite article comprising multiple webs, e.g., a single stratum in a first web having first and second major surfaces defining the thickness of the web, when that web is overlaid or underlaid by a second web having first and second major surfaces defining the thickness of the second web, in which case each of the first and second webs forms at least one layer. In addition, layers may simultaneously exist within a single web and between that web and one or more other webs, each web forming a layer.

“Particulate density gradient,” “sorbent density gradient,” and “fiber population density gradient” mean that the amount of particulate, sorbent or fibrous material within a particular fiber population (e.g., the number, weight or volume of a given material per unit volume over a defined area of the web) need not be uniform throughout the nonwoven fibrous web, and that it can vary to provide more material in certain areas of the web and less in other areas.

Various exemplary embodiments of the disclosure will now be described with particular reference to the Drawings. Exemplary embodiments of the invention may take on various modifications and alterations without departing from the spirit and scope of the disclosure. Accordingly, it is to be understood that the embodiments of the invention are not to be limited to the following described exemplary embodiments, but is to be controlled by the limitations set forth in the claims and any equivalents thereof.

Nonwoven fibrous structures (e.g., nonwoven fibrous webs, etc.) have a plurality of applications (e.g., uses) including: cleaning applications, filtration applications, and/or textile applications, among others. Nonwoven fibrous structures can be better suited to particular applications when the nonwoven fibrous structure exhibits particular characteristics (e.g., fire retardant characteristics, antistatic characteristics, antibacterial characteristics, antimicrobial characteristics, antifungal characteristics, etc.). The present disclosure describes nonwoven fibrous structures that include a portion of a population of fibers that are bonded together with an ionic reinforcement material and methods of making the same. The ionic reinforcement material provides an increase in the tensile strength of the nonwoven fibrous structure as well as provides a number of characteristics. In some exemplary embodiments, the ionic reinforcement material provides a plurality of characteristics as described herein.

As described further herein, the ionic reinforcement material can be applied to the nonwoven fibrous structure utilizing an application of an ionic liquid material. The ionic liquid material can include an ionic liquid (e.g., liquid comprising at least one cation and at least one anion). The ionic liquid material can be applied to the nonwoven fibrous structure with a phenolic binder that can be cured to bind a portion of the population of fibers of the nonwoven fibrous structure with an ionic reinforcement material.

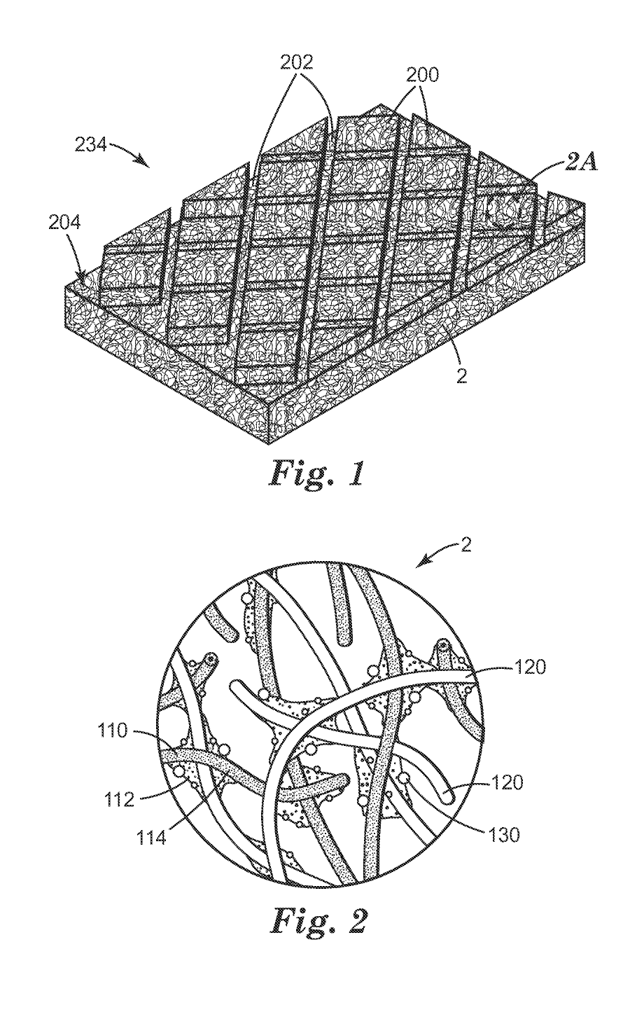

FIG. 1 is a perspective view of one exemplary embodiment of a nonwoven fibrous structure 234 (e.g., air-laid nonwoven fibrous web, melt-spun nonwoven fibrous web, carded nonwoven fibrous web, etc.) comprising a plurality of randomly oriented fibers according to the present disclosure. In some exemplary embodiments, the nonwoven fibrous structure 234 is a structure selected from the group consisting of a mat, a web, a sheet, a scrim, or a combination thereof.

In some optional embodiments, the present disclosure describes a nonwoven fibrous structure 234 comprising a plurality of randomly oriented fibers 2, the nonwoven fibrous structure 234 further comprising a plurality of optional non-hollow projections 200 extending from a major surface 204 of the nonwoven fibrous structure 234 (as considered without the projections), and a plurality of substantially planar land areas 202 formed between each adjoining projection 200 in a plane defined by and substantially parallel with the major surface 204.

In some exemplary embodiments, the randomly oriented discrete fibers 2 can include fibers 120 selected from the group consisting of mono-component fibers, multi-component fibers, crimped fibers, or a combination thereof. In certain exemplary embodiments, the randomly oriented discrete fibers 2 can include fibers selected from the group consisting of staple fibers, melt blown fibers, natural fibers, or a combination thereof. In some exemplary embodiments, the randomly oriented discrete fibers 2 can include natural fibers selected from cotton, wool, jute, agave, sisal, coconut, soybean, hemp, viscose, bamboo, or a combination thereof. In certain exemplary embodiments, the randomly oriented discrete fibers 2 can include fibers that exhibit a median fiber diameter of from 1 micrometer to 50 micrometers.

In some exemplary embodiments, the randomly oriented discrete fibers 2 can include thermoplastic (co)polymer fibers further comprising a (co)polymer selected from poly(propylene), poly(ethylene), poly(butane), poly(ethylene) terephthalate, poly(butylene) terephthalate, poly(ethylene) napthalate, poly(amide), poly(urethane), poly(lactic acid), poly(vinyl)alcohol, poly(phenylene) sulfide, poly(sulfone), liquid crystalline polymer, poly(ethylene)-co-poly(vinyl)acetate, poly(acrylonitrile), cyclic poly(olefin), poly(oxymethylene), poly(olefinic) thermoplastic elastomers, recycled fibers containing any of the preceding thermoplastic (co)polymers, or a combination thereof.

The randomly oriented discrete fibers 2 may, in some exemplary embodiments, optionally include filling fibers 110. The filling fibers 110 are any fiber other than a multi-component fiber. The optional filling fibers 110 are preferably mono-component fibers, which may be thermoplastic or “melty” fibers. In certain exemplary embodiments, the filling fibers can include bio-based fibers. Bio-based fibers can include natural fibers and/or biodegradable fibers. For example, the optional filling fibers 110 may, in some exemplary embodiments, comprise natural fibers, more preferably natural fibers derived from renewable sources, and/or incorporating recycled materials. Non-limiting examples of suitable natural fibers include those of bamboo, cotton, wool, jute, agave, sisal, coconut, sawgrass, soybean, hemp, and the like. Cellulosic fibers (e.g., cellulose, cellulose acetate, cellulose triacetate, rayon, and the like) may be particularly well-suited natural fibers. The fiber component used may be virgin fibers or recycled waste fibers, for example, recycled fibers reclaimed from garment cuttings, carpet manufacturing, fiber manufacturing, textile processing, paper, reclaimed wood, or the like. In another example, the optional filling fibers 110 are biodegradable fibers. The biodegradable fibers can include, but are not limited to fibers comprising a substantial amount of aliphatic polyester (co)polymer derived from poly(lactic acid), poly (glycolic acid), poly (lactic-co-glycolic acid) blends, and/or a combination thereof. In some presently preferred embodiments, at least some of the filling fibers 120 may be bonded to at least a portion of the discrete fibers 2 at a plurality of intersection points with the first region 112 of the multi-component fibers 110.

In some exemplary embodiments of the previously described nonwoven fibrous structure 234, the nonwoven fibrous structure 234 may optionally include a plurality of particulates 130 as shown in FIGS. 2-2B. FIGS. 2-2B illustrate exploded views of region 2 of the nonwoven fibrous structure 234 of FIG. 1, shown comprising randomly oriented discrete fibers 2 and a plurality of optional particulates 130.

In some exemplary embodiments, the optional particulates 130 can be particulates selected from the group consisting of abrasive particulates, detergent particulates, anti-bacterial particulates, adsorbent particulates, absorbent particulates, or a combination thereof. In certain exemplary embodiments, the optional population of particulates 130 can exhibit a median particle diameter of from 0.1 micrometer to 1,000 micrometers. The optional particulates 130 can be applied at various stages of the forming process for the nonwoven fibrous structure 234. In one example, the optional particulates can be applied by a particulate loading process. Exemplary particulate loading processes are taught in, for example, U.S. Pat. Nos. 4,818,464 and 4,100,324.

Additionally, in some particular exemplary embodiments, an input stream may advantageously be located to introduce particulates 130 in a manner such that the particulates 130 are distributed substantially uniformly throughout the nonwoven fibrous structure 234. Alternatively, in some particular exemplary embodiments, an input stream may advantageously be located to introduce particulates 130 in a manner such that the particulates 130 are distributed substantially at a major surface of the nonwoven fibrous structure 234, for example, proximate a lower major surface of nonwoven fibrous structure 234, or proximate the upper major surface of the nonwoven fibrous structure 234.

In certain exemplary embodiments, a binder can be applied to the nonwoven fibrous structure 234 and may provide further strength to the nonwoven fibrous structure 234, may further secure the particulates 130 to the fibers of the nonwoven fibrous structure 234, and/or may provide additional stiffness for an abrasive or scouring article. The binder coating may be applied by known processing means such as roll coating, spray coating, and immersion coating and combinations of these coating techniques. The binder coating may include additional particulates 130 within the binder or additional particulates 130 may be incorporated and secured to the binder. In certain exemplary embodiments, a thermosetting binder is applied to the population fibers. The thermosetting binder can include a binder that is cured when heat is applied to the binder. The thermosetting binder can be applied from the phenolic resin material, the ionic liquid material, a mixture separate from a phenolic resin material and the ionic liquid material, or a combination thereof. That is, the thermosetting binder can be applied as part of the phenolic resin material, as part of the ionic liquid material, or as a separate application either before or after the application of the phenolic resin material and/or the ionic liquid material. In some exemplary embodiments, the binder includes a phenolic binder (e.g., phenolic resin material with a binder, phenolic novolac resin binder, phenol-formaldehyde binder, resole phenolic binders, etc.).

In certain exemplary embodiments, a phenolic resin material is applied to the nonwoven fibrous structure 234. The phenolic resin material can comprise a phenolic resin and water (e.g., phenolic resin in an aqueous mixture, phenolic resin in an aqueous solution, etc.). The phenolic resin material can be applied to the nonwoven fibrous structure 234 by known processing means such as roll coating, spray coating, and immersion coating and combinations of these coating techniques.

In some exemplary embodiments, an ionic liquid material (e.g., ionic liquid material) can be coated on a nonwoven fibrous structure (e.g., nonwoven fibrous structure 234) that includes the applied phenolic resin material. For example, in specific embodiments, a phenolic resin material is applied via a roll coating to the nonwoven fibrous structure 234 and the ionic liquid material is applied via a spray coating to the nonwoven fibrous structure 234 that includes the applied phenolic resin material. In some exemplary embodiments, the phenolic resin material is applied prior to the application of the ionic liquid material. That is, applying the phenolic resin material takes place before applying the ionic liquid material. In certain exemplary embodiments, the phenolic resin material is applied after the application of the ionic liquid material. That is, applying the phenolic resin material takes place after applying the ionic liquid material.

The ionic liquid material can include an ionic liquid (e.g., liquid that comprises at least one cation and at least one anion, aqueous solution that comprises at least one cation and at least one anion). That is, the ionic liquid material can include an ionic liquid solution in a solvent, where optionally the solvent is aqueous. In some exemplary embodiments, the ionic liquid can include at least one cation that is selected from the group containing heterocyclic cations, ammonium, phosphonium, or sulfonium. In addition, in certain exemplary embodiments, the ionic liquid can include at least one anion that is selected from the group consisting of halogen anions, fluorine containing anions, alkyl sulfate anions, alkyl phosphate anions, acetate, dicyanamide (N(CN)₂), or thiocyanate (SCN). The ionic liquid can be comprised of a salt dissolved in a liquid. For example, the ionic liquid material can comprise a salt dissolved in water to produce an ionic liquid that comprises at least one cation and at least one anion in an aqueous solution. In some exemplary embodiments, the ionic liquid can include at least one of the ionic liquids from the group of: sodium chloride (NaCl), choline dihydrogen phosphate, 1-ethyl-3-methylimidazolium ethyl phosphate, 1-ethyl-3-methylimidazolium ethyl sulfate, 1-ethyl-3-methylimidazolium acetate, 1-ethyl-3-methylimidazolium triflate, or 1-ethyl-3-methylimidazolium dicyanamide.

The ionic liquid material may be applied by known processing means such as roll coating, spray coating, and immersion coating and combinations of these coating techniques. In some exemplary embodiments, the ionic liquid material is introduced as a mist from an atomizer within a forming chamber. In certain exemplary embodiments, the ionic liquid wets the fibers so that particulates cling to the surface of the fibers. In certain exemplary embodiments, the ionic liquid material can be coated on the nonwoven fibrous structure 234, wherein the nonwoven fibrous structure 234 also includes a coating of a phenolic resin as described herein. In certain exemplary embodiments, the phenolic resin material and the ionic liquid material can be applied utilizing a twin spraying process (e.g., simultaneous or nearly simultaneous spraying) of the ionic liquid material and of the phenolic resin. That is, a first spraying technique utilizing the phenolic resin and a second spraying technique utilizing the ionic liquid material can be applied to the same and/or similar area of the nonwoven fibrous structure 234.

In some exemplary embodiments, the phenolic resin within the phenolic resin material undergoes a phase separation from the phenolic resin material. The phase separation of the phenolic resin from the phenolic resin material can comprise precipitating the phenolic resin by removing at least some of the water from the phenolic resin material. In some exemplary embodiments, the phenolic resin material comprising the phenolic resin and water can separate upon the addition of the ionic liquid material. In certain exemplary embodiments, the phase separation of the phenolic resin from the phenolic resin material can decrease a time that is needed to remove excess liquid (e.g., water) from the nonwoven fibrous structure 234. The decrease in time needed to remove the excess water can save a cost of forming the nonwoven fibrous structure 234. The residual phenolic resin can bind the plurality of fibers within the nonwoven fibrous structure 234.

A number of devices can be utilized to remove excess liquid (e.g., water) from the nonwoven fibrous structure 234. In some exemplary embodiments calendaring can be utilized to remove liquid from the nonwoven fibrous structure 234. In certain exemplary embodiments, the number of devices can include a number of squeegees that can compress the nonwoven fibrous structure 234 and remove a portion of the liquid (e.g., water) that is applied to the nonwoven fibrous structure 234. In certain exemplary embodiments, the number of squeegees can be utilized before the nonwoven fibrous structure 234 is moved to a heating unit (e.g., oven, etc.) to remove liquid that was not removed by the number of squeegees. In other embodiments, the number of devices can be located at various points of the formation process of the nonwoven fibrous structure 234.

The heating unit can also be utilized for curing the ionic liquid material and/or the phenolic resin material applied to the nonwoven fibrous structure 234. That is, the heating unit can be utilized after the ionic liquid material and/or phenolic resin material are applied to the nonwoven fibrous structure 234. In addition, the heating unit can be utilized to remove liquid (e.g., water) that exists on and/or within the nonwoven fibrous structure 234. As described herein, the heating unit can remove liquid that remains after a number of devices are utilized to remove liquid and/or after the phase separation of the phenolic resin material. Removing the liquid can produce an ionic reinforcement material (e.g., phenolic resin and ionic liquid material, residual of the ionic liquid material) at locations where the ionic liquid material and/or phenolic resin material were applied to the nonwoven fibrous structure 234.

The ionic reinforcement material can bond a portion of the population of fibers. As described herein, the ionic reinforcement material can include a residual material of the ionic liquid material. In some exemplary embodiments, the ionic reinforcement material can include a residual material of the ionic liquid material and the phenolic binder applied to the nonwoven fibrous structure 234. That is, the ionic reinforcement material can include a residual material from the an interaction that occurs between the ionic liquid material and the phenolic binder that are each applied to the nonwoven fibrous structure 234. In some exemplary embodiments, the ionic reinforcement material is a residual material of the ionic liquid material (e.g., material remaining after liquid is removed from the ionic liquid material and phenolic resin material applied to the nonwoven fibrous structure 234). That is, in some exemplary embodiments, the ionic reinforcement material is the residual of the ionic liquid material after the liquid (e.g., water) is removed from the nonwoven fibrous structure 234. The ionic reinforcement material can provide an adhesive bond between the portion of the population of fibers when the phenolic resin material and the ionic liquid material are each applied to the nonwoven fibrous structure 234, as described herein. In some exemplary embodiments, the fibers of the nonwoven fibrous structure 234 can be bonded together with a reaction product of a phenolic binder (e.g., phenolic resin material) and the ionic reinforcement material. In this embodiment, the ionic reinforcement material can be a residual material from an application of an ionic liquid and an application of the phenolic binder to the plurality of fibers. That is, the ionic reinforcement material can be a residual material of a reaction (e.g., chemical reaction, etc.) between the ionic liquid material and the phenolic binder when both are applied to the nonwoven fibrous structure 234. The reaction can occur when the ionic liquid material and the phenolic binder are mixing (e.g., interacting, etc.) after application to the nonwoven fibrous structure 234.

The ionic reinforcement material can provide a number of characteristics to the nonwoven fibrous structure 234. The ionic reinforcement material can provide the number of characteristics when the ionic reinforcement material includes a residual of the ionic liquid material and/or and a phenolic binder applied to the nonwoven fibrous structure 234, as described herein. In some exemplary embodiments, the number of characteristics can include a fire retardant characteristic, an antistatic characteristic, an antibacterial characteristic, an antimicrobial characteristic, an antifungal characteristic, or a combination thereof. In certain exemplary embodiments, the ionic reinforcement material provides at least one of the number of characteristics. In some exemplary embodiments, the ionic reinforcement material provides a plurality of the number of characteristics as described herein. In some exemplary embodiments, the ionic reinforcement material can provide at least two of the number of characteristics listed herein.

In one exemplary embodiment, the ionic reinforcement material is applied with an ionic liquid material comprising the ionic liquid choline dihydrogen phosphate and an application of a phenolic resin material as described herein. In this exemplary embodiment, the nonwoven fibrous structure 234 is less brittle (e.g., increased elongation, increased plasticity, increased fluidity) with the addition of the choline dihydrogen phosphate and addition of the phenolic resin material compared to a nonwoven fibrous structure 234 with only the addition of the phenolic resin material. In addition, the nonwoven fibrous structure 234 comprises antistatic characteristics from the ionic reinforcement material. As described further herein, the addition of the ionic liquid choline dihydrogen phosphate and phenolic resin material to the nonwoven fibrous structure 234 can provide additional fire retardant (e.g., flame retardant) characteristic to nonwoven fibrous structure 234. The ionic reinforcement material can also add additional characteristics such as: a fire retardant characteristic, an antistatic characteristic, an antibacterial characteristic, an antimicrobial characteristic, an antifungal characteristic, or a combination thereof.

As described herein, the ionic reinforcement material can increase the elongation (e.g., plasticity or fluidity) of the nonwoven fibrous structure 234. The ionic reinforcement material can also provide an increase in a tensile strength of the nonwoven fibrous structure 234. In some exemplary embodiments the ionic reinforcement material can provide an increase in a tensile strength of the nonwoven fibrous structure 234 and an increase in elongation of the nonwoven fibrous structure 234. In some exemplary embodiments, the increase in tensile strength and the increase in elongation are in the machine direction (MD) of the nonwoven fibrous structure 234.

A nonwoven fibrous structure 234 (e.g., fibrous web, air-laid nonwoven fibrous web, etc.) according to the present disclosure can be formed utilizing a number of forming methods (e.g., melt-spinning, air-laying, spun-bonding, carding, etc.). In exemplary embodiments, the nonwoven fibrous structure 234 is formed by air-laying fiber processing equipment, such as shown and described in U.S. Pat. Nos. 7,491,354 and 6,808,664.

In some exemplary embodiments, the air laying fiber processing equipment can use air flow to mix and inter-engage the fibers to form an air laid nonwoven fibrous structure. That is, the air laid nonwoven fibrous structure is formed by introducing a plurality of fibers into a forming chamber and dispersing the fibers within the forming chamber to form a population of individual fibers suspended in a gas, wherein the fibers are allowed to fall down to a collector.

In particular embodiments, instead of using strong air flow to mix and inter-engaged the fibers to form an air-laid nonwoven fibrous structure (such as with a “RandoWebber” web forming machine, available from Rando Machine Corporation, Macedon, N.Y.), the forming chamber can have spike rollers to blend and mix the fibers while gravity allows the fibers to fall down through the endless belt screen and form an air-laid nonwoven fibrous structure of inter-engaged fibers. With this construction of air-laying equipment, the fibers and the particulates are, in some exemplary embodiments, falling together to the bottom of the forming chamber to form the air-laid nonwoven fibrous structure. In one exemplary embodiment, a vacuum can be included below the area where the air-laid nonwoven fibrous structure forms in the forming chamber.

In some exemplary embodiments, the nonwoven fibrous structure 234 is formed using a carding process. An exemplary carding process is taught in, for example, U.S. Pat. No. 5,114,787. In some exemplary embodiments, the nonwoven fibrous structure 234 is formed by a meltblowing process. The meltblowing process is a method for forming a nonwoven fibrous structure by extruding a molten fiber-forming material through a plurality of orifices in a die to form fibers while contacting the fibers with air or other attenuating fluid to attenuate the fibers into fibers, and thereafter collecting the attenuated fibers. An exemplary meltblowing process is taught in, for example, U.S. Pat. No. 6,607,624.

The ionic liquid material can be applied to the nonwoven fibrous structure 234 at different stages of each of the forming methods. In some exemplary embodiments, as described herein, the ionic liquid material can be applied to fibers and/or filaments during a formation (e.g., in a forming chamber, etc.) of the fibers and/or filaments utilizing a mist process to spray the fibers and/or filaments while they are being collected on a collector. In some exemplary embodiments, as described herein, the ionic liquid material can be applied to the nonwoven fibrous structure 234 once the fibers and/or filaments are collected on a collector. In this embodiment, the ionic liquid material can be applied by known processing means such as roll coating, spray coating, and immersion coating and combinations of these coating techniques. In addition, the phenolic resin can be applied by known processing means such as roll coating, spray coating, and immersion coating and combinations of these coating techniques. Furthermore, as described herein, the phenolic resin can be applied to the nonwoven fibrous structure 234 at a first time utilizing a first application process and the ionic liquid material can be applied to the nonwoven fibrous structure 234 at a second time utilizing a second application process. In some exemplary embodiments, the first application process and the second application process can be different application processes. In other embodiments, the first application process and the second application process can be the same application process. As described herein, the first time and the second time can be different times, such as the first time being an earlier time than the second time. In other embodiments, the first time and the second time can be the same time or about the same time (e.g., nearly the same time period, relatively the same time period, etc.).

Nonwoven fibrous structures of the present disclosure and filter media including the same may, in some exemplary embodiments, advantageously incorporate a biodegradable material, a particulate material, a frame material, or a combination thereof. Some filter media incorporating biodegradable material (e.g. polyhydroxy alkonates (PHA), polyhydroxybutyrates (PHB), and the like) may, at the end of their useful life, be disposed of advantageously in municipal land-fills or industrial composting sites, thereby eliminating the need to return or otherwise recycle the spent filter media.

The operation of various embodiments of the present disclosure will be further described with regard to the following detailed Examples.

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

### Test Methods

Testing of the formed nonwoven fibrous webs was carried out using the testing apparatus listed in Table I, according to the methods described further below. In all testing procedures, a standard reference sample (i.e., comparative example), denoted “Std.” was measured for comparison. The standard reference samples (i.e., comparative examples) consisted of the corresponding web coated with binder only and no ionic liquid additive.

TABLE I
Testing Apparatus

| Apparatus | Supplier |
|---|---|
| Balance | Mettler Toledo, Inc. |
| Instron 5965 | Instron Instruments, Inc. |

### Basis Weight

The basis weight of the nonwoven fibrous webs was measured with a Mettler Toledo XS4002S electronic balance.

### Tensile Strength and Percent Elongation

Tensile strength and percent (%) elongation measurements were carried out on nonwoven samples (15×2.5 cm) on an Instron 5965 machine with a maximum load of 100N. For each nonwoven sample, three samples were measured and the average obtained.

### Raw Materials

Unless otherwise noted, all parts, percentages, ratios, etc. in the Examples and the rest of the specification are by weight. Solvents and other reagents used may be obtained from Sigma-Aldrich Chemical Company (Milwaukee, Wis.) unless otherwise noted. In addition, Table II provides abbreviations and a source for all materials used in the Examples below:

TABLE II
Raw Materials

| Raw Material | Supplier |
|---|---|
| Phenol-formaldehyde resin | Momentive Performance |
| 7953 SW | Chemicals |
| Acrylic fibers (16 denier) | National Trading, Inc. |
| FC 4400 Anti stat | 3M Company, St. Paul, MN |

In the following examples, “IL” denotes ionic liquid, “PET” denotes polyester, “MD” denotes machine direction, “TD” denotes transverse direction (relative to MD), “TS” denotes tensile strength, “elong” denotes percentage elongation, “PEG” denotes polyethylene glycol, “Std.” denotes a reference standard (i.e., a comparative example).

### Binder

Phenolic Resin (Approx. 65% Solids in Aqueous Solution):

Unless otherwise stated, the phenolic resin was added to the nonwoven web in a separate processing step to the addition of the IL. The phenolic resin was either roll coated or sprayed on the web either prior to or following the IL and cured in through air ovens for 4-8 minutes following temperature profiles ranging from 120° C. to 170° C.

Ionic Liquids

The ionic liquid was diluted in H₂O (10% aqueous solution unless otherwise stated) prior to addition to the web or the phenolic binder. The IL was added to the nonwoven web in a separate processing step to the phenolic binder, either prior to or after binder coating.

TABLE III
Ionic Liquids (IL)

| Ionic Liquid | |
|---|---|
| Reference Code | Chemical Name |
| IL A | 1-ethyl-3-methylimidazolium diethyl phosphate |
| IL B | 1-ethyl-3-methylimidazolium ethyl sulfate |
| IL C | 1-ethyl-3-methylimidazolium acetate |
| IL J | 1-hexyl-3-methylimidazolium triflate |
| IL K | 1-methyl-3-octylimidazolium triflate |
| IL M | 1-butyl-3-methylimidazolium dicyanamide |
| IL N | 1-allyl-3-methylimidazolium chloride |
| IL O | Trihexyltetradecylphosphonium chloride |
| IL P | FC4400 |
| IL E1 | Choline dihydrogen phosphate |
| IL H1 | 1-ethyl-3-methylimidazolium chloride |
| IL I1 | Larostat HTS 905 |
| IL J1 | 1-butyl-3-methylimidazolium chloride |

### Fibers

Mixtures of fibers (viscose, PET, nylon) with low melting fibers were formed in a ratio of 80:20 fiber:low melting fiber, and processing of the fiber mixture of Table IV was carried out using the nonwoven processing equipment listed in Table V.

TABLE IV
Fibers

| | Prebond Web Basis Weight |
|---|---|
| FiberPrebond Web | (g/m²) |
| Viscose | 80 |
| PET | 70 |
| Nylon | 95 |

TABLE V
Nonwoven Processing Equipment

| Machine | Supplier |
|---|---|
| Fiber opener | Laroche |
| Rando Webber | Rando Machine Corporation |
| Roll coater | Cavitec |
| Paint Preparation System | 3M |

### Web Formation

Fibrous prebonded webs were formed prior to coating of the resins. The required ratio of fibers to melty fibers were weighed and mixed by passing through a fiber opener. The air-laid prebonded webs were formed on a Rando Webber forming machine. Following forming of the web, it was sent through a through-air oven at 130° C. to yield a lightly bonded web suitable for coating trials.

### Web Consolidation

Various combinations of roll coating and spraying were used to coat the nonwoven webs, followed by passing through ovens for curing. Roll coating consisted of passing the webs through roll coating cylinders containing the binder or ionic liquid in the reservoir. The spray step was performed using a PPS system with either the binder or the aqueous dilution of the ionic liquid. Various methods were used for coating the ionic liquid and phenolic binder onto the pre-formed nonwoven webs:

Method A: Roll coat phenolic resin followed directly by spray IL aqueous solution
Method B: Roll coat IL aqueous solution followed by spray phenolic resin
Method C: Spray IL solution followed by roll coat of phenolic resin
Method D: Spray phenolic resin followed by spray ionic liquid solution
Method E: Spray IL solution followed by spray phenolic resin
Method F: Roll coat phenolic resin followed directly by spray IL aqueous solution, subsequently followed by passing through squeegee rolls for water removal

### Example 1

The nonwoven samples tested consisted of viscose prebond webs. Method A was used. The reference standard material was cured in the oven using normal procedures. The IL sprayed samples were left to dry without mechanical heating before testing.

Tables 1-4 show the Tensile Test results for Example using viscose prebond webs with various ionic liquids.

TABLE 1

| | TS - | TS - | TS - | TS - |
|---|---|---|---|---|
| Method A | MD | MD | MD | MD Average |
| A Std. | 1.69 | 2.55 | 1.28 | 1.84 |
| C ILI1 | 3.23 | 3.16 | 3.65 | 3.35 |
| D ILE1 | 3.44 | 2.35 | 3.26 | 3.02 |
| E ILH1 | 1.13 | 1.51 | 1.51 | 1.38 |

TABLE 2

| | Elongation - | Elongation - | Elongation - | Elongation - |
|---|---|---|---|---|
| Method A | MD | MD | MD | MD Average |
| A Std. | 1 | 1.27 | 1 | 1.09 |
| C ILI1 | 2.37 | 2.37 | 2.65 | 2.46 |
| D ILE1 | 6.22 | 3.2 | 6.5 | 5.31 |
| E ILH1 | 18.6 | 21.07 | 21.07 | 20.25 |

TABLE 3

| | TS - | TS - | TS - | TS - |
|---|---|---|---|---|
| Method A | TD | TD | TD | TD Average |
| A Std. | 0.87 | 1.23 | 0.94 | 1.01 |
| C ILI1 | 3.23 | 3.09 | 3.31 | 3.21 |
| D ILE1 | 1.63 | 1.68 | 2.26 | 1.86 |
| E ILH1 | 1.17 | 0.71 | 1.19 | 1.02 |

TABLE 4

| | Elongation - | Elongation - | Elongation - | Elongation - |
|---|---|---|---|---|
| Method A | TD | TD | TD | TD Average |
| A Std. | 1 | 1.55 | 1.27 | 1.27 |
| C IL I1 | 3.47 | 3.47 | 4.3 | 3.75 |
| D IL E1 | 2.92 | 3.2 | 6.22 | 4.11 |
| E IL H1 | 42.24 | 31.25 | 34.27 | 35.92 |

### Example 2

Nylon and PET prebond webs were used with IL C in 50% aqueous solution. Web consolidation method C was used. Tables 5-6 show the Tensile Test results for Example using Nylon and PET prebond webs with IL C.

TABLE 5

| | TS - | TS - | TS - | TS - |
|---|---|---|---|---|
| Method C | MD | MD | MD | MD Average |
| 1: Nylon std. | 1.1 | 0.99 | 1.3 | 1.13 |
| 2: Nylon + IL | 1.78 | 1.47 | 1.5 | 1.58 |
| 3: PET std. | 0.56 | 0.62 | 0.64 | 0.61 |
| 4: PET + IL | 0.73 | 0.82 | 0.87 | 0.81 |

TABLE 6

| | Elongation - | Elongation - | Elongation - | Elongation - |
|---|---|---|---|---|
| Method C | MD | MD | MD | MD Average |
| 1: Nylon std. | 13.08 | 12.27 | 18.32 | 14.56 |
| 2: Nylon + IL | 18.87 | 16.67 | 19.97 | 18.50 |
| 3: PET std. | 27.94 | 25.74 | 30.42 | 28.03 |
| 4. PET + IL | 39.77 | 44.17 | 44.45 | 42.80 |

### Example 3

Viscose prebond nonwoven webs were used. Phenolic resin cure temperature was as follows: 130° C. followed by 110° C. at 1 m/min. for 8 minutes. Tables 7-8 show the Tensile Test results for Example 3 using Viscose prebond nonwoven webs with various ionic liquids.

TABLE 7

| | TS - | TS - | TS - | TS - |
|---|---|---|---|---|
| Method A | MD | MD | MD | MD Average |
| Std. | 3.64 | 4.21 | 3.7 | 3.85 |
| IL A | 4.49 | 4.59 | 4.53 | 4.54 |
| IL J | 2.03 | 2.01 | 1.63 | 1.89 |
| IL K | 3.3 | 3.1 | 4.05 | 3.48 |
| IL M | 3.2 | 4.9 | 3.92 | 4.01 |
| IL N | 3.26 | 3.53 | 2.67 | 3.15 |
| IL O | 1.99 | 2.98 | 2.82 | 2.60 |
| IL P | 4.12 | 3.8 | 4.54 | 4.15 |

TABLE 8

| | Elongation - | Elongation - | Elongation - | Elongation - |
|---|---|---|---|---|
| Method A | MD | MD | MD | MD Average |
| Std. | 1.27 | 1.54 | 1.55 | 1.45 |
| IL A | 4.29 | 4.57 | 4.85 | 4.57 |
| IL J | 5.12 | 8.97 | 10.9 | 8.33 |
| IL K | 2.64 | 1.82 | 2.92 | 2.46 |
| IL M | 6.77 | 8.42 | 7.87 | 7.69 |
| IL N | 10.9 | 4.85 | 5.95 | 7.23 |
| IL O | 1.05 | 5.95 | 10.34 | 5.78 |
| IL P | 9.52 | 7.32 | 8.7 | 8.51 |

### Example 4

Nylon and PET nonwoven webs were used. Method B was used with IL C 30% aqueous solution. Tables 9-10 show the Tensile Test results for Example 4 using Nylon and PET nonwoven webs with various ionic liquids.

TABLE 9

| | PET TS - | Nylon TS - |
|---|---|---|
| Method B | MD | MD |
| Std. 1 | 0.47 | 1.20 |
| Std. 2 | 0.49 | 1.47 |
| IL B | 0.46 | 0.97 |
| IL C | 0.21 | 0.99 |
| IL J1 | 0.66 | 0.99 |

Std. 1: Sprayed with phenolic resin
Std. 2: Coated with water and then sprayed with phenolic resin

TABLE 10

| | PET Elong - | Nylon Elong - |
|---|---|---|
| Method B | MD | MD |
| Std. 1 | 33.91 | 32.58 |
| Std. 2 | 41.38 | 21.72 |
| IL B | 42.94 | 43.39 |
| IL C | 31.88 | 35.65 |
| IL J1 | 52.65 | 24.37 |

Std. 1: Sprayed with phenolic resin
Std. 2: Coated with water and then sprayed with phenolic resin

### Increased Processing Speeds

The following examples further illustrate the potential of using the methods described herein to separate the phenolic binder phase from the aqueous phase on the nonwoven web and thus allowing for alternate water removal (squeegee rolls/vacuum) as opposed to heating energy.

### Example 1

A: Phenolic roll coated followed directly by applying heat from static oven

B: Phenolic roll coated. followed by NaCl aqueous application and squeezing for H₂O removal. Sample then submitted to heating in static oven. Table 11 summarizes the coating and curing conditions.

TABLE 11

| | | | | | | Total |
|---|---|---|---|---|---|---|
| | | | | | | Heating |
| | Temp. | Wt. After Coating | | Wt. After Oven | | Time |
| Ref. | (° C.) | A | B | A | B | (min.) |
| 1 | 160 | 14.52 | 6.88 | 4.54 | 3.65 | 11 |
| 2 | 170 | 13.39 | 6.89 | 4.16 | 3.97 | 9 |
| 3 | 180 | 13.72 | 6.47 | 4.52 | 3.55 | 8 |
| 4 | 190 | 16.55 | 6.90 | 6.76 | 3.83 | 6 |

### Example 2

### Acrylic Prebond Web. Phenolic Binder (3:1 Binder:H₂0)

### Method F

The coated prebond was sent through two consecutive ovens totaling a distance of 8 meters at a speed of 1 m/min. The weight of the sample was measured following the exit from oven 2. The sample was passed again through oven 2 and the weight was again measured. The sample was deemed fully cured when there was no variation in weight between oven passages.

The standard samples (12 X and Y) consisted of roll coating phenolic binder and passing directly through ovens. The sprayed samples (13 X and Y) consisted of an extra spraying step following phenolic roll coating, thus followed by a squeezing step to remove the excess H₂O prior to passage through the ovens. When the extra steps are employed, with 13 X and Y, it can be seen that the third passage through the oven is not required and that the weight has stabilized following the second passage.

The effect of IL/NaCl spray oven residence time was also investigated, and the conditions investigated are summarized in Tables 12-14:

TABLE 12

| | Oven 1 | Oven 2 |
|---|---|---|
| Length (m) | 4 | 4 |
| Temperature (° C.) | 150 | 170 |
| Speed (m/min.) | 2 | 1 |

TABLE 13

| | | | | Weight Removed | |
|---|---|---|---|---|---|
| | Sample Weight After Multiple | | | Between Pass (g) | |
| | Passes Through Oven 2 (g) | | | Between | Between |
| | Pass 1 | Pass 2 | Pass 3 | 1 and 2 | 2 and 3 |
| 12X Std. | 0.1243 | 0.0844 | 0.0795 | 0.0399 | 0.0049 |
| 12Y Std. | 0.1440 | 0.0925 | 0.0857 | 0.0515 | 0.0068 |
| 13X NaCl 30% | 0.0751 | 0.0749 | — | 0.0002 | — |
| 13Y NaCl 30% | 0.0808 | 0.0805 | — | 0.0003 | — |

TABLE 14

| | Residence | Residence | Total Residence |
|---|---|---|---|
| | Time Oven 1 | Time Oven 2 | Time |
| | (min.) | (min.) | (min.) |
| 12 Std. | 2 | (4 × 2.5) | 12 |
| 13 Spray | 2 | 4 | 6 |

The tensile strength and elongation of these samples were also measured in order to ensure the mechanical properties resisted the extra processing steps.

### Surface Resistivity Test Results

The surface resistivity of the nonwoven coated samples was carried out according to VDE 0303 part 30. The test equipment consisted of a Teraohmmeter (PM 126 567), electrode (20 cm²) and Ø Electrode (5 cm). The following terms are defined for the Surface Resistivity Test:

| | |
|---|---|
| σ [Ω] | surface resistivity |
| Rx [Ω] | measured surface resistivity |
| p [cm] | effective scope of the protected electrode |
| g [cm] | distance between the electrodes |

Various fiber samples cured with phenolic resin and various ionic liquids were evaluated for Surface Resistivity as shown in Tables 15-18:

TABLE 15

| Sample | Ref. | Rx Avg. |
|---|---|---|
| Std. PET | 1 | 1.E+10 |
| Std. Nylon | 2 | 2.E+10 |
| PET IL C | 3 | 4.E+10 |
| Nylon IL C | 4 | 7.E+09 |

TABLE 16

| | Rx | σ | Voltage |
|---|---|---|---|
| Sample | [Ω] | [Ω] | [V] |
| 1 | 3.22E+10 | 5.15E+12 | 500 |
| | 2.23E+08 | 3.57E+10 | 500 |
| | 3.17E+09 | 5.07E+11 | 500 |

TABLE 17

| | Rx | σ | Voltage |
|---|---|---|---|
| Sample | [Ω] | [Ω] | [V] |
| 2 | 7.59E+09 | 1.22E+12 | 500 |
| | 1.97E+09 | 3.16E+11 | 500 |
| | 5.29E+10 | 8.48E+12 | 500 |

TABLE 18

| | Rx | σ | Voltage |
|---|---|---|---|
| Sample | [Ω] | [Ω] | [V] |
| 3 | 3.67E+10 | 5.88E+12 | 500 |
| | 4.38E+09 | 0.00E+00 | 500 |
| | 7.48E+10 | 1.20E+13 | 500 |
| | Rx | | Voltage |
| Sample | [Ω] | [Ω] | [V] |
| 4 | 1.34E+09 | 2.14E+11 | 500 |
| | 5.69E+09 | 9.11E+11 | 500 |
| | 1.51E+10 | 2.42E+12 | 500 |

Table 19 summarizes overall performance properties observed with respect to Tensile Strength, Anti-static properties, and Flame Retardancy when curing a phenolic resin in the presence of an ionic liquid to bond together the nonwoven fibers in the web.

TABLE 19
Multi-functional Ionic Liquids—Performance Summary

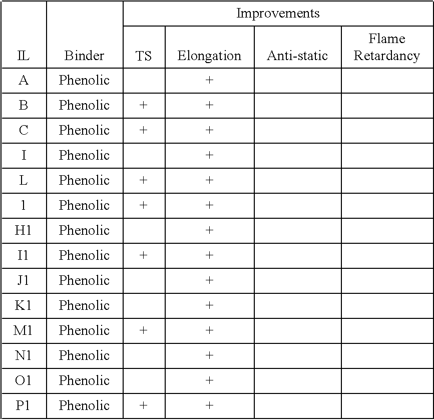

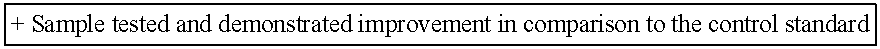

Reference throughout this specification to “one embodiment,” “certain exemplary embodiments,” “one or more embodiments” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain exemplary embodiments,” “in one embodiment” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove.

Furthermore, all publications and patents referenced herein are incorporated by reference in their entirety to the same extent as if each individual publication or patent was specifically and individually indicated to be incorporated by reference. Various exemplary embodiments have been described. These and other embodiments are within the scope of the following claims.

1. A method of making a nonwoven structure, comprising:
introducing a plurality of fibers into a forming chamber;
dispersing the fibers within the forming chamber to form a population of individual fibers suspended in a gas;
collecting the population of fibers as a nonwoven fibrous web on a collector;
applying a phenolic resin material to the population of fibers;
applying an ionic liquid material to the population of fibers; and
bonding at least a portion of the population of fibers together by curing the applied phenolic resin material, the applied ionic liquid material, or both the applied phenolic resin material and the applied ionic liquid material.

2. The method of claim 1, wherein the phenolic resin material comprises a phenolic resin and water.

3-6. (canceled)

7. The method of claim 1, wherein applying the phenolic resin material takes place before applying the ionic liquid material.

8. (canceled)

9. The method of claim 1, wherein applying the phenolic resin material and applying the ionic liquid material take place substantially simultaneously, optionally wherein the phenolic resin material and the ionic liquid material are combined to form a combined mixture before application to the population fibers.

10. (canceled)

11. The method of claim 1, wherein bonding at least the portion of the population of fibers together by curing includes heating the portion of the population of fibers.

12. The method of claim 1, wherein bonding at least the portion of the population of fibers together by curing provides a nonwoven fibrous structure with a tensile strength that is greater than a nonwoven fibrous structure formed by bonding at least the portion of the population of fibers together in the absence of the ionic liquid material.

13. (canceled)

14. The method of claim 1, wherein the ionic liquid material comprises at least one cation and at least one anion, optionally wherein the at least one cation is selected from the group consisting of nitrogen containing heterocyclic cations, ammonium, phosphonium, or sulfonium; and further wherein the at least one anion is selected from the group consisting of halogen anions, fluorine containing anions, alkyl sulfate anions, alkyl phosphate anions, acetate, dicyanamide (N(CN)2), or thiocyanate (SCN).

15-16. (canceled)

17. The method of claim 1, further comprising applying a thermosetting binder to the population fibers.

18-20. (canceled)

21. The method of claim 1, wherein the ionic reinforcement material provides at least one distinguishing characteristic to the nonwoven fibrous structure selected from the group consisting of a fire retardant characteristic, an antistatic characteristic, an antibacterial characteristic, an antimicrobial characteristic, an antifungal characteristic, or a combination thereof.

22-23. (canceled)

24. The method of claim 1, wherein the nonwoven fibrous structure includes a population of particulates bonded to the nonwoven fibrous structure, further wherein the particulates are selected from the group consisting of abrasive particulates, detergent particulates, anti-bacterial particulates, adsorbent particulates, absorbent particulates, or a combination thereof.

25-26. (canceled)

27. A nonwoven structure comprising:
a population of randomly oriented fibers bonded together using a phenolic binder and an ionic reinforcement material.

28. The nonwoven fibrous structure of claim 27, wherein the population of randomly oriented fibers is bonded together with a reaction product of the phenolic binder and the ionic reinforcement material.

29. The nonwoven fibrous structure of claim 27, wherein the ionic reinforcement material is a residual material from an application of an ionic liquid and the phenolic binder too the fibers.

30. The nonwoven fibrous structure of claim 29, wherein the ionic liquid comprises water, one or more cations, and one or more anions, optionally wherein the ionic liquid comprises an imidazolium cation with a corresponding anion.

31. (canceled)

32. The nonwoven structure of claim 27, exhibiting at least one distinguishing characteristic selected from the group consisting of a fire retardant characteristic, an antistatic characteristic, an antibacterial characteristic, an antimicrobial characteristic, or an antifungal characteristic.

33-34. (canceled)

35. The nonwoven fibrous structure of claim 27, wherein the population of fibers includes fibers selected from the group consisting of mono-component fibers, multi-component fibers, crimped fibers, or a combination thereof.

36. The nonwoven fibrous structure of claim 27, wherein the population of fibers includes fibers selected from the group consisting of staple fibers, melt blown fibers, natural fibers, bio-based fibers, or a combination thereof.

37. The nonwoven fibrous structure of claim 27, wherein the population of fibers includes thermoplastic (co)polymer fibers further comprising a (co)polymer selected from poly(propylene), poly(ethylene), poly(butane), poly(ethylene) terephthalate, poly(butylene) terephthalate, poly(ethylene) napthalate, poly(amide), poly(urethane), poly(lactic acid), poly(vinyl)alcohol, poly(phenylene) sulfide, poly(sulfone), liquid crystalline polymer, poly(ethylene)-co-poly(vinyl)acetate, poly(acrylonitrile), cyclic poly(olefin), poly(oxymethylene), poly(olefinic) thermoplastic elastomers, recycled fibers containing any of the preceding thermoplastic (co)polymers, or a combination thereof.

38. The nonwoven fibrous structure of claim 27, wherein the population of fibers includes natural fibers selected from cotton, wool, jute, agave, sisal, coconut, soybean, hemp, viscose, bamboo, or a combination thereof.

39. The nonwoven fibrous structure of claim 27, wherein the nonwoven fibrous structure includes a population of particulates bonded to the nonwoven fibrous structure, further wherein the particulates are selected from the group consisting of abrasive particulates, detergent particulates, anti-bacterial particulates, adsorbent particulates, absorbent particulates; or a combination thereof.

40-42. (canceled)
